(19) United States
(12) Patent Application Publication
(10) Pub. No.: US 2008/0233364 A1
(43) Pub. Date: Sep. 25, 2008

(54) DIMENSIONALLY STABLE LAMINATE AND METHOD

(76) Inventors: Brent K. Larson, Fairlawn, OH (US); Matt D. Breen, Streetsboro, OH (US); Terry Pugh, Ravenna, OH (US)

Correspondence Address: ROETZEL & ANDRESS, 1375 EAST 9TH STREET, CLEVELAND, OH, 44114, US

(21) Appl. No.: 12/052,827

(22) Filed: Mar. 21, 2008

Related U.S. Application Data
(60) Provisional application No. 60/923,843, filed on Apr. 16, 2007.
(60) Provisional application No. 60/919,617, filed on Mar. 23, 2007.

(51) Int. Cl. B32B 3/00; B32B 37/00

(52) U.S. Cl. 428/196; 156/182

(57) ABSTRACT

Various embodiments of a dimensionally stable laminates and the method of producing the laminates are provided. In one embodiment, a dimensionally stable laminate structure includes a reinforcement layer having a polymer selected from polyester, phenolic, epoxy and mixtures thereof, and from about 20% to about 80% by weight fiber reinforcement. The multi-layered laminate also includes a surface layer having a substrate layer which includes a polymer selected from polyvinyl chloride, polyester, phenolic, epoxy and mixtures thereof, and from about 20% to about 80% by weight fiber reinforcement. The surface layer also includes a decorative layer comprising a polymer selected from the group: polyvinyl chloride, polyurethane, acrylic and mixtures thereof. An adhesive primer layer is adhered to the reinforcement layer and an adhesive layer is disposed between the surface layer and the adhesive primer layer. The adhesive primer layer is a material composition that is different than the adhesive layer. In various example embodiments the dimensionally stable laminate is a continuous roll-formed laminate product.

### RELATED APPLICATION DATA

This application claims priority to U.S. provisional patent application No. 60/923,843 filed Apr. 16, 2007 and No. 60/919,617 filed Mar. 23, 2007, entitled, DIMENSIONALLY STABLE LAMINATE AND METHOD, listing inventors Brent K. Larson, Matt D. Breen and Teny L. Pugh.

### FIELD OF THE INVENTION

The present invention relates to multi-layered decorative laminates which include a decorative layer and the method for making the same. More specifically, the present invention relates to multi-layer laminates having improved dimensional stability, and methods of producing the laminates.

### BACKGROUND OF THE INVENTION

Decorative and structural panels for architectural and transport vehicle applications are commonly laminates which have a surface layer and a reinforcement layer. The surface layer often includes a decorative layer, or Outer cover, affixed to a substrate layer, to provide rigidity and low weight. Decorative layers typically have an exterior surface that is an embossed texture, or a print pattern, or a combination of these and other aesthetic design features.

In transport vehicle applications for example, maintaining uniformity of the texture and print pattern design features of the decorative portion of the laminate throughout the manufacturing process is desirable. For example, non-textile flooring (NTh) laminates are constructed using multiple layers of various films laminated together under high temperature and pressure, and/or embossed, again at high temperature and pressure, at different stages in a continuous roll-forming manufacturing process.

Conventional methods for the manufacture of such laminates are limited by the properties of the materials used which impose limitations on the extent to which the combined layers can be heated, stretched and further processed in casting and roll-forming machinery without adversely affecting the dimensional stability of the final product. Laminates have three basic dimensions which can be represented by reference to x, y, and z axis, where the z-axis represents the thickness of the laminate. In conventional laminates, permanent distortion occurs along the x or y axis, or both, when the laminate is heated and stretched in one or more directions as a result of forces applied in a mechanical lamination process. As the laminate cools it retains such distortion.

In some applications, laminate structures are of a construction which results in a higher than desired weight to ensure rigidity and stability. In addition, structural laminates which provide adequate performance characteristics for aviation flooring and available as sheets have dimensional limitations which can result in unnecessary waste in end-use applications.

### SUMMARY

The present invention provides for various laminate constructions having desired aesthetic properties, for example texture and graphical features, and which also maintain excellent dimensional stability in manufacturing, such as a roll-forming manufacturing process, for example. In one embodiment, a dimensionally stable laminate structure includes a reinforcement layer having, by weight, from about 20% to about 80% thermoset polymer selected from polyester, phenolic, epoxy and mixtures thereof, and from about 20% to about 80% reinforcement fiber. The multi-layered laminate also includes a surface layer which includes a decorative layer and a substrate layer. The substrate layer includes from about 20% to bout 80% reinforcement fiber and from about 20% to about 80% polymer selected from polyvinyl chloride, polyester, phenolic, epoxy and mixtures thereof. The decorative layer is selected from polyvinyl chloride, acrylic, polyurethane, and mixtures thereof. An adhesive layer is disposed between the substrate layer or the surface layer and an adhesive primer layer adhered to the reinforcement layer. The composition of the adhesive primer layer is different than the adhesive layer. In another embodiment, the laminate structure is lightweight and has an areal density of about 3000 grams per square meter or less.

In additional embodiments, various laminate structures further include at least two decorative layers with a second decorative layer disposed on the decorative layer. In yet additional embodiments the laminate structure further includes a protective layer disposed on the decorative layer or the second decorative layer if present. The protective layer can include polyvinyl chloride, polyurethane, acrylic and mixtures thereof.

In any of the embodiments described above, in accordance with the present invention, the method for making a laminate structure includes laminating the surface layer and the reinforcement layer in a roll-forming process. In one embodiment, the method includes applying an adhesive to an adhesive primer layer which is adhered to a reinforcement layer, applying the adhesive also to a substrate layer, and laminating at a temperature ranging from about 170° F. to about 300° F. the reinforcement layer and the substrate layer such that the adhesive applied to the adhesive primer layer contacts the adhesive layer applied to the substrate layer. The reinforcement layer includes a fiber reinforcement of woven fabric and a thermoset polymer selected from the group of: polyester, phenolic, epoxy, and mixtures thereof. The substrate layer includes a fiber reinforcement of woven fabric and a polymer selected from polyvinyl chloride, polyester, phenolic, epoxy and mixtures thereof. In example embodiments the continuous roll-formed laminate has an areal density of about 3000 grams per square meter or less. In addition, the example laminate structures described above can have an impact resistance greater than about 5 Joules according to a modified ISO 6603-1 method A.

### BRIEF DESCRIPTION OF THE DRAWINGS

The various embodiments of the present invention can be understood with reference to the following drawings. The components in the drawings are not necessarily to scale. Also, in the drawings, like reference numerals designate corresponding parts throughout the views.

FIG. 1 is a perspective view illustration of a laminate structure, according to all embodiment of the present invention;

FIG. 2 is a perspective illustration of a laminate structure having an optional second decorative layer and an optional protective layer, according to an embodiment of the present invention;

FIG. 3A is a schematic illustration of a portion of a roll-forming line and embossing equipment used in the method of making a laminate structure, according to an embodiment of the present invention; and

FIG. 3B is a schematic illustration of a portion of a toll-forming line, and lamination equipment used in the method of making a laminate structure, according to an embodiment of the present invention.

### DETAILED DESCRIPTION OF THE INVENTION

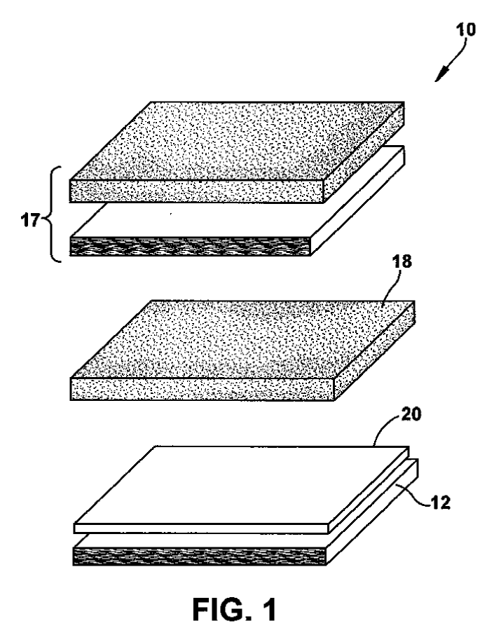

FIG. 1 is an exploded perspective illustration of a laminate structure 10 according to an embodiment of the present invention. FIG. 1 shows laminate structure 10 includes a reinforcement layer 12 and a substrate layer 14. The laminate structure 10 optionally includes a decorative layer 16, and the decorative layer 16 adhered to the substrate layer 14 are collectively referred to as the surface layer 17.

The reinforcement layer 12 includes a fiber-reinforced thermoset polymer made from a woven fabric with impregnated thermoset resin. Suitable thermoset resins include, but are not limited to, unsaturated polyester, phenolic, epoxy, and mixtures thereof. The term “unsaturated” is used in reference to a thermoset polymer, for example, of a thermoset polymer used in the method of forming the laminate structure and refers to a molecule having one or more carbon-carbon double bonds, and is capable of further polymerization in a curing process, for example, by exposure to elevated temperatures. Once the “unsaturated” polymer has been cured and is present in the laminate structure, it is no longer referred to herein as an “unsaturated” polymer even though it may not be fully saturated in the cured state. For example, in various embodiments of the manufactured laminate structure in which polyester is present in the reinforcement layer, or the adhesive layer, or both, the polymer is referred to herein as “polyester” even though it may not be filly saturated in the cured state of the laminate structure.

The amount, by weight, of thermoset resin present in the reinforcement layer 12, can range from about 20% to about 80%, in another embodiment from about 30% to about 70%, and in another embodiment from about 40% to about 50%. The reinforcement layer 12 contains, by weight, from about 20% to about 80% reinforcement fiber, and in another example embodiment, from about 30% to about 70% by weight fiber, and in yet another embodiment from about 50% to about 60% by weight fiber.

In one embodiment, the reinforcement layer is sufficiently stiff to provide good telegraph resistance, but sufficiently flexible to provide low weight and enable laminate structure 10 to roll on core, for example 3-inch to 6-inch diameter cores, for example. Telegraph resistance is an attribute of some structural laminates, for example, decorative NTF laminates that keeps any unevenness in the underlying layer from being readily observed because of the stiffiess of the decorative NTF laminate. In addition, laminates available as continuous roll material offers economic advantages because less material is wasted when custom geometric pieces are cut from the roll.

The substrate layer 14 can be made from a woven fabric impregnated or coated with resin. The resin can include, but is not limited to, polyvinyl chloride (PVC), polyester, phenolic, epoxy and mixtures thereof. For example, in one embodiment, the woven fabric is coated with organisol which is a mixture of PVC, plasticizer and solvent. The solvent allows the organisol composition to penetrate into the woven fabric, for example a glass fabric. The solvent is evaporated and then the organisol is fused.

Fiber materials which can be used in the reinforcement layer 12 and the substrate layer 14 of laminate structures of the present invention can include, for example, glass, aramids, carbon, polyvinyl alcohol (PVA), hemp, jute, organic materials, and rayon. Depending upon the material of the fiber woven fabric and its specific gravity, the areal density of the laminate can vary from about 100 grams per square meter to about 400 grams per square meter and all ranges therebetween. For example, in various embodiments in which glass is used as the reinforced fiber, the areal density of glass in at least one of the reinforcement layer 12 and the substrate layer 14 ranges from about 200 to about 400 grams per square meter, in another embodiment, from about 250 to about 350 grams per square meter, and in another embodiment from about 275 to about 325 grams per square meter. In another example embodiment in which aramid fiber is used, the areal density of the fiber woven fabric of the at least one of the reinforcement layer 12 and the substrate layer 14 ranges from about 100 to about 300 grams per square meter, for example.

Adhesive 18 is shown disposed between the reinforcement layer 12 and the substrate layer 14. Adhesive 18 contains a thermoplastic resin which can include, but is not limited to, polyurethane, for example a polyester-based polyurethane; polyamide; polyvinyl alcohol; polyester; and mixtures thereof, for example, as well as additional thermoplastic polymers having similar melting temperatures and adhesive properties as the examples listed above, and mixtures thereof. In another embodiment, adhesive layer 18 includes two or more thermoplastic polymers. For example, a suitable adhesive layer 18 includes, by weight, from about 70% to about 90% of a polymer as listed above, for example a polyester-based polyurethane, and also includes from about 10% to about 30% by weight of a second thermoplastic polymer selected from the group of: polyamide, polyvinyl alcohol, polyester, phenoxy and mixtures thereof.

The amount of adhesive layer 18 present in laminate structure 10, and disposed between reinforcement layer 12 and substrate layer 14, can range from about 70 to about 150 grams per square meter, in another example, from about 70 to about 100 grams per square meter, in another example, from about 70 to about 90 grams per square meter. The adhesive 18 can be a heat-activated adhesive which melts during lamination at elevated temperature as will be further described.

Adhesive 18 optionally contains a flame retardant additive in quantities based on parts per hundred resin. Suitable flame retardants include, but are not limited to, aluminum trihydrate, antimony-containing compounds, polybrominated diphenyl ethers, magnesium hydroxide, organophosphates, red phosphorous, halogenated phosphorus compounds, zinc borate, and mixtures thereof. The amount of flame retardant, alone or as a mixture of two or more flame retardant additives, can be present in up to about 40 parts per hundred resin, in another embodiment up to about 20 parts per hundred resin, in another embodiment up to 15 parts per hundred resin, and in yet another embodiment up to about 10 parts per hundred resin, and all ranges therebetween. Also, it should be understood that a flame retardant additive is optional and therefore, in another embodiment, the adhesive 18 contains no flame retardant additive. That is, when the adhesive contains no flame retardant additive, any flame retardant performance if present in the adhesive layer would be characteristic of the inherent properties of the at least one thermoplastic polymer used in the adhesive layer 18.

As described above, the laminate structure further includes an adhesive primer layer 20 disposed between the reinforcement layer 12 and the adhesive 18. In one example embodiment, the adhesive primer 20 is a thermoset adhesive containing a resin which can include, but is not limited to, polyester, polyurethane, epoxy, acrylic, and mixtures thereof. The amount of adhesive primer 20 disposed between the reinforcement layer and the adhesive 18 is greater than about 5 grams per square meter, in another example, the adhesive prima can range from about 5 to about 30 grams per square meter, in another example, from about 10 to about 25 grams per square meter, in another example, from about 15 to about 20 grams per square meter. These amounts are based on a dry weight present in the laminate.

In another embodiment, laminate structure 10 includes a decorative layer 16. In one example embodiment the decorative layer 16 and includes, but is not limited to, a polymer selected from polyvinyl chloride (PVC), acrylic, polyurethane and mixtures thereof. For example, decorative layer 16 includes a plastisol, which is a composition containing polyvinyl chloride (PVC) and plasticizer. A suitable plastisol, for example, includes, by weight, from about 60% to about 75% polyvinyl chloride with the remainder being substantially plasticizer. The plastisol provides high elongation and toughness properties characteristic of an elastomer such as rubber. In another embodiment the decorative layer 16 can include flame retardant additives. For example, a decorative layer 16 which contains plastisol or alternative polymers can contain at least one flame retardant additive. Suitable flame retardants include, but are not limited to, aluminum trihydrate, antimony-containing compounds, polybrominated diphenyl ethers, magnesium hydroxide. organophosphates, red phosphorous, halogenated phosphorus compounds, zinc borate, and mixtures thereof. The amount of flame retardant, alone or as a mixture of two or more flame retardant additives, can be present in up to about 40 parts per hundred resin, in another embodiment up to about 20 parts per hundred resin, in another embodiment up to 15 parts per hundred resin, and in yet another embodiment up to about 10 parts per hundred resin, and all ranges therebetween.

In various example embodiments of the present invention, the laminate structure includes a reinforcement layer having, by weight, from about 40% to about 50% polyester, and from about 50% to about 60% fiber reinforcement. The surface layer includes a substrate layer and a decorative layer. The substrate layer includes polyvinyl chloride (PVC) and from about 20% to about 80% by weight woven fiber. The decorative layer includes polyvinyl chloride (PVC) and plasticizer. An adhesive layer which includes thermoplastic polyurethane is disposed between the reinforcement layer and the substrate layer of the surface layer. The laminate includes an adhesive primer layer disposed between reinforcement layer and the thermoplastic adhesive layer. The adhesive primer includes a thermoset polymer selected from the group: polyester, polyurethane, acrylic, and mixtures thereof. In example embodiments, at least one of the reinforcement layer and the substrate layer includes fiber reinforcement having an areal density which ranges from about 100 grams per square meter to about 400 grams per square meter. In another embodiment the adhesive is comprised of a thermoplastic polyester-based polyurethane in an amount of about 70 to about 90 phr with a phenoxy resin in an amount of about 10 to about 30 phr. The laminate structure can be lightweight roll-formed laminate product having excellent dimensional stability and impact resistance as will be further described.

The surface layer which includes the decorative layer 16 and the substrate layer 14, adheres well to the reinforcement layer 12 such that the peel resistance between the surface layer and the reinforcement layer 12, after aging for 500 hours at 70° C., is at least about 25 Newtons (N) per 25 millimeters (mm), in another example, at least about 35 N/25 mm, in another embodiment, the peel resistance ranges from about 40 N/25 mm to about 60 N/25 mm, and in another embodiment, the peel resistance is about 50 N/25 mm, after aging 500 hours at 70° C. according to ISO 4578 test method. In another embodiment the failure mode is a cohesive substrate failure.

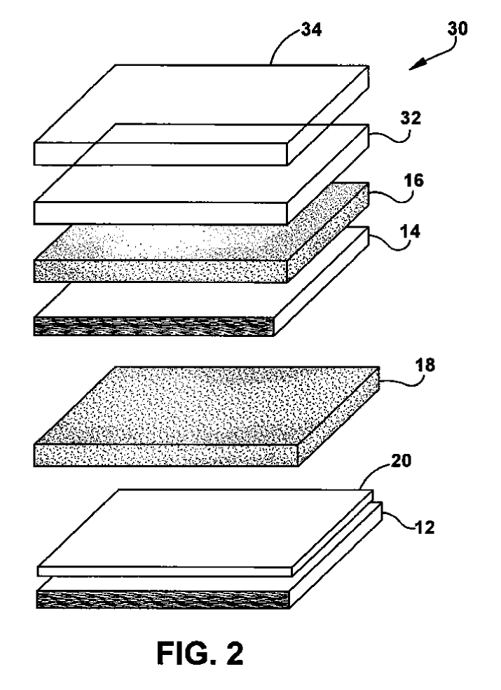

FIG. 2 is an exploded view illustration of laminate structure 30 which includes the components of laminate structure 10, and further includes a second decorative layer 32, a protective layer 34, or both.

Second decorative layer 32 can include, but is not limited to, at least one or more of, a print layer, a metal layer, a varnish, a polymer. For example, the second decorative layer can be at least one of a printed pattern, an embossed pattern which provides texture, and color. The protective layer 34 can be a clear, transparent, or translucent material, for example, so mat the second decorative layer can be seen.

The structural laminates of the present invention, for example laminates 10 and 30, include a decorative capability in which a decorative pattern, for example, a geometric texture, a printed ink pattern, and the like, of the surface layer has a deviation from linear in both machine and cross machine directions of less than about 2 millimeter, in another example, less than about 1.5 millimeter, and in another example, less than about 1.0 millimeter, over about a 4 meter length of the laminates 10 and 30. For example, the decorative pattern is that of decorative layer 16 or decorative layer 34, or both. The magnitude of deviation is measured by extending a string from two points that should be aligned and looking for deviation from the line represented by the string. Any deviation from the string is measured to the accuracy of one tenth of a millimeter.

The laminate structures of the present invention are relatively light weight, having a maximum areal density up to about 3000 grams per square meter, in another embodiment about 2300 grams per square meter or less, in another example, less than about 2000 grams per square meter, and in yet another example, an areal density which ranges from about 1800 to about 2300 grams per square meter. In addition, the laminate structures herein, for example laminate structures 10 and 30, are dimensionally stable, having less than 0.5% change after 168 hours at 70° C., in another embodiment, less than 0.2% dimensional change, and in another embodiment, less than 0.1% dimensional change after 168 hours at 70° C.

Laminate structures herein have an abrasion resistance shown by Tabor abrasion testing, ISO 9352 with mass loss of less than about 600 milligrams, in another embodiment, less than about 500 milligrams, and in another embodiment, less than about 400 milligrams. Laminate structure 30 of FIG. 2 for example, can have improved abrasion resistance with the presence of protective layer 34, with or without the presence of second decorative layer 32.

Laminate structures herein when tested according to FAA specifications, the dynamic coefficient of friction is greater than about 0.45 for wet and dry sled with either rubber or leather as described in FAR 25.793 Amendment 25-51 procedure.

Laminate structures of the present invention, for example laminates 10 and 30, have an impact resistance of at least about 5 Joules, in another embodiment, at least about 9 Joules, and in another embodiment, at least about 14 Joules, according to a modified ISO 6603-1 method. A test where the striker is a blunted cone shape with the diameter of the blunt tip is 3.2 mm and the cone diameter increases at a 60 degree angle from the blunt tip until the diameter is 34.9 mm. Impact energy is defined as the energy required to cause 50% of the aviation floor panels to fail when tested with energy greater than the impact energy. The floor panel failure is defined as when a probe of 0.32 mm diameter penetrates with only minimal hand force through the face ply of the aviation floor panels.

The tear strength of laminate structures herein is greater than about 40 Newtons, in another embodiment, greater than about 60 Newtons, and in another embodiment, greater than about 75 Newtons according to ISO 4674, method A.

In another embodiment, laminate structures herein are stain resistant as per ISO 4586-2, clause 15, method A, Procedure A, rating 5.

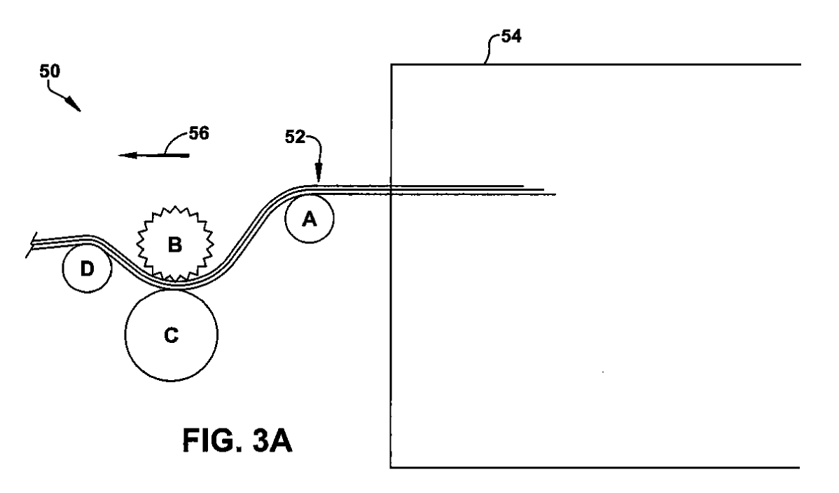

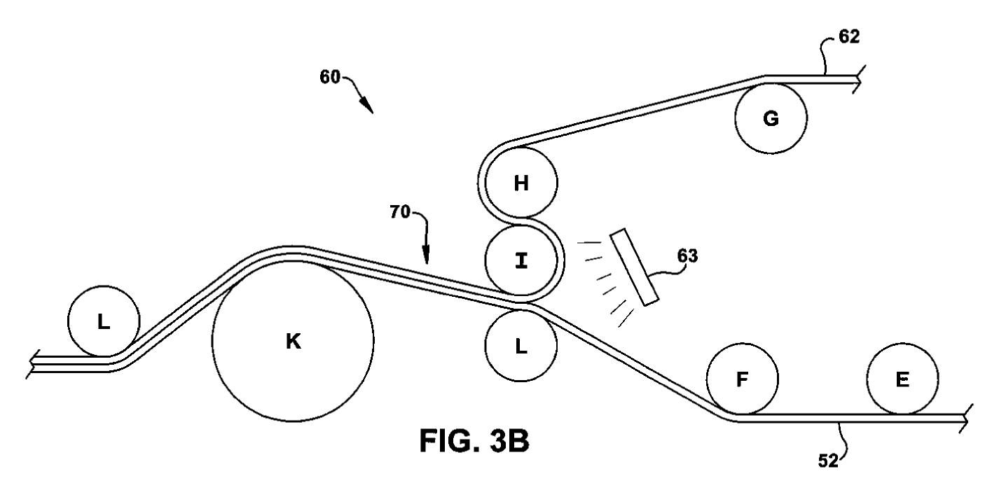

FIGS. 3a and 3b illustrate a continuous roll-forming type lamination method by which embodiments of dimensionally stable laminates of the present invention, for example, laminates 10 and 30 described above are made. Continuous roll-forming is distinguished from an alternative press process by which sheets of laminates structures are made, however, laminates of the present invention can also be made by the press method. FIG. 3a shows the embossing portion of the continuous roll-forming method of making the laminate structures. Surface layer 52, can include substrate layer 14 and at least one decorative layer, for example decorative layer 16 of FIGS. 1 and 2, and may also include additional decorative layers, for example decorative layer 32 of FIG. 2, and/or a protective layer, for example protective layer 34 of FIG. 2. Surface layer 52 is shown exiting oven 54 in the direction indicated by arrow 56 and moves across a first roller A, and into an embossing roller combination B and C and then is moved across roller D. The embossing roller B imparts a texture to the surface layer 52.

Prior to embossing, surface layer 52, which includes substrate layer 14 (FIGS. 1 and 2) can be applied well-established coating processes known to those skilled in the art. For example, surface layer 52 can be produced by dipping a fiber reinforced polymer into a polymer solution. For example, a woven fabric, such as a woven glass fabric, can be dipped into polymer solution, for example an organisol, which includes polyvinyl chloride, plasticizer, and solvent, and passing through a heat zone to drive off the solvent. At least one decorative layer, for example decorative layer 16 of FIGS. 1 and 2, and any additional decorative layers, for example decorative layer 32 of FIG. 2, and/or protective layer, for example protective layer 34 of FIG. 2 can be applied to the substrate layer according to well-established coating processes in order to produce the surface layer 52.

FIG. 3b shows the lamination of surface layer 52 and reinforcement layer 62. The lamination process can be physically connected to the embossing line or may also be physically separated from the embossing line, but in any event is a portion of the overall roll-forming method. Both the surface layer 52 and reinforcement layer 62 are heated in a heat zone, by heater 63 which can be an infra-red heater, for example, and fed between rollers I and J to produce laminate structure 70.

Prior to lamination, both the reinforcement layer 62 and the surface layer 52 include a coating of adhesive which ultimately forms adhesive layer 18. The amount of adhesive applied to each of the surface layer 52 and the reinforcement layer 62, can range from about 35 to about 75 grams per square meter, in another embodiment from about 35 to about 60 grams per square meter, and in another embodiment from about 35 to about 50 grams per square meter, and all ranges therebetween. In another embodiment, the amount of adhesive applied to the surface layer is greater than the amount of adhesive applied to the reinforcement layer. For example, the ratio or the amount of adhesive applied to the adhesive primer layer on the reinforcement layer 62 to the amount of adhesive applied to substrate layer of the surface layer 52, can range from about 1:1 to about 1:2, and in another embodiment from about 1:1 to about 1:1.5.

Roll G is the let-off roll for the reinforcement layer 62 and B is the let-off roll for the surface layer 52. Rollers H and F feed the reinforcement layer and surface layer to the laminating rolls L and J. The cooling roll K ensures quick cooling of the laminate and then it is rolled up on roll L. Roller I is a heated laminated roll which can be larger than the others to increase the surface contact of the laminate against the heated roll I. Cooling roller K can also be relatively large to increase the surface area of by which the laminate contacts roller K for more efficient cooling.

It has been found that a superior combination of adhesion and dimensional stability is obtained when heat active adhesive 18 is applied to both sides of the bond, that is, the substrate layer 14 (FIGS. 1, 2) of the surface layer and the opposing reinforcement layer 12 (FIGS. 1,2), or optionally, the primer 20 (FIGS. 1,2) prior to laminating the surface layer and the reinforcement layer 12. Also, when the adhesive 18 is applied to both the substrate layer 14 and the reinforcement layer 12 prior to lamination, then the lamination step may be carried out at a relatively low surface temperature that ranges from about 170° F. to about 300° F., in another embodiment from about 170° F. to about 250° F., and in another embodiment from about 170° F. to about 220° F.

The resulting laminate structure made by the roll-forming process can have various dimensions, for example a fixed width along its length, such as about 1.5 meters wide, and variable length, for example, greater than about 6.5 meters long, in another example, from about 10 meters to about 25 meters long, and in another example, at least about 30 meters long.

The processing parameters may vary depending on the chemistry of adhesive and primer and the thickness of the laminate. For example, the temperature may vary as noted above and the pressure may vary from about 20 psi to about 40 psi. The roller speed can also vary and can range from about 2 meters/minute to about 5 meters/minute, and in other example embodiments, from about 2.5 meters/minute to about 4 meters/minute.

It is to be understood that for purposes of the present specification and claims that the range and ratio limits recited herein can be combined. For example, if ranges of 10 to 100 and 20 to 90 are recited for a particular parameter, it is understood that the ranges of 10 to 90 and 20 to 100 are also contemplated. Independently, if minimum values for a particular parameter are recited, for example, to be 1, 2, and 3, and if maximum values for that parameter are recited to be, for example, 8 and 9, then the following ranges are all contemplated: 1 to 8, 1 to 9, 2 to 8, 2 to 9, 3 to 8, and 3 to 9.

The following examples of dimensionally stable laminates made according to embodiments of the present invention are further disclosed, and do not otherwise limit the scope of the invention.

### EXAMPLES

Control Samples 1-116:

A laminate in roll form was made in the construction described with respect to FIG. 1. The reinforcement layer was made from a thermoset unsaturated polyester/glass fabric composite, containing approximately 45% by weight polyester and approximately 55% by weight glass fabric, and the surface layer included a substrate layer having PVC/glass fabric, containing approximately 25% by weight PVC and approximately 75% by weight glass fabric. Adhesive primer was placed on one side of the reinforcement layer and was cured. Approximately 60 grams per square meter of a thermoplastic adhesive containing approximately 60% polymer and approximately 40% of flame retardant additives, was placed on the substrate layer, and the surface layer was laminated to the reinforcement layer. The polymer of the adhesive layer included 85 phr polyester-based polyurethane and 15 phr phenoxy resin. The flame retardant additives used included decabromodiphenyl ether, antimony trioxide, zinc borate, and mixtures thereof. The reinforcement layer containing the primer was heated to a temperature of about 400° F. in order to adhere the reinforcement layer to the substrate layer of the surface layer. The control specimens were tested and the results are listed in Table I. The Impact test was a modified ISO 6603-1 method. A test using a blunted cone shape striker as described above. Impact energy is defined as the energy required to cause 50% of the aviation floor panels to fail when tested with energy greater than the impact energy. The floor panel failure is defined as when a probe of 0.32 mm diameter penetrates with minimal hand force through the face ply of the aviation floor panels.

### Examples 1-126

A laminate roll having the same layer components and composition as that described above in the control samples was prepared. Approximately 60 grams per square meter of adhesive was placed on the substrate layer of the surface layer and approximately 30 grams per square meter of adhesive was placed on the reinforcement layer prior to lamination. The surface layer and also the reinforcement layer, both containing adhesive, were heated to 220° F. and were laminated. The results are listed in Table 2 below.

TABLE 1

| | | | | | No. & Size of | | | |
|---|---|---|---|---|---|---|---|---|
| | | | | | Test Specimen | | | |
| Control | Properties | | | Test Methods | Units | Specification | Units | Result |
| | Thickness | | | ISO 2286-3 | Spaced across | Max 3.7 | mm | 1.73 |
| | | | | | the usable | | | |
| | | | | | width | | | |
| 1-5 | Total mass per unit area | | | ISO 2286-2 | 5 × (100 × 100) | Max 2300 | g/m2 | 2122 |
| 6-8 | Static coefticient | dry | MD | ISO 8295 | 3 × (300 × 95) | 0.25 | | 0.74 |
| 9-11 | of friction | | CMD | | 3 × (300 × 95) | 0.25 | | 0.91 |
| 12-14 | | wet | MD | | 3 × (300 × 95) | 0.25 | | 0.68 |
| 15-17 | | | CMD | | 3 × (300 × 95) | 0.25 | | 0.77 |
| 18-20 | Dynamic | dry | MD | | 3 × (300 × 95) | 0.25 | | 0.39 |
| 21-23 | coefficient of | | CMD | | 3 × (300 × 95) | 0.25 | | 0.42 |
| 24-26 | friction | wet | MD | | 3 × (300 × 95) | 0.25 | | 0.41 |
| 27-29 | | | CMD | | 3 × (300 × 95) | 0.25 | | 0.43. |

| 30-32 | Dimensional stability | | EN 434 | 3 × (240 × 240) | Plus/minus | % | 0 |
|---|---|---|---|---|---|---|---|
| | | | | | 0.2 | | |
| 33-35 | Curling | | EN 434 | 3 × (240 × 240) | Max 10 | mm | 0 |
| 36-38 | Abrasion-loss in mass | | ISO 9352 | 3 × (Φ 100) | 1000 | mg | 383 |
| 39 | 50% impact-failure energy | | ISO 6603-1′ | 1 × (300 × 300) | 9 | J | |
| | | | Method A | | | | |
| 40-44 | Tear strength | MD | ISO 4674 | 5 × (200 × 150) | 60 | N | 66.62 |
| 45-49 | | CMD | Method A | 5 × (200 × 150) | 60 | N | 81.54 |
| 50-54 | Peel resistance between | MD | ISO 4578 | 5 × (250 × 25) | 50 or CSF | N | 53.94 |
| 55-59 | surface layer & reinforcing | CMD | | 5 × (250 × 25) | 50 or CSF | N | 36.49 CFS |
| | backing | | | | | | |
| 60-64 | Peel resistance between | MD | | 5 × (250 × 25) | 20 or CSF | N | 38.99 |
| 65-69 | surface layers | CMD | | 5 × (250 × 25) | 20 or CSF | N | 46.11 |

| 70-74 | Bondability (peel resistance) | | ISO 4578 | 5 × (250 × 25) | 20 | N/25 mm | |
|---|---|---|---|---|---|---|---|
| 75-79 | Scalability (peel resistance) | | ISO 8510-2 | 5 × (360/200 × 25) | NO AF | N/25 mm | |
| | Weldability | | EN 684 | | 250 | N/50 mm | |
| 81-82 | Stain resistance | Citic acid | ISO 4586-2 | 2 × (any) | RATING 5 | | RATING 5 |
| | against | 10% | clause 15 | | | | |
| 83-84 | | Alcoholic | procedure A | 2 × (any) | RATING 5 | | RATING 5 |
| | | beverages red | | | | | |
| | | wine | | | | | |
| 85-86 | | Urea 20% | | 2 × (any) | RATING 5 | | RATING 5 |
| | | solution | | | | | |

| | | | | | | | |
|---|---|---|---|---|---|---|---|
| 87-89 | Flammability, vertical, | MD | AITM | 3 × (300 × 75) | 203, 15, 5 | mm, s, s | |
| 90-92 | 12's | CMD | 2.0002B | 3 × (300 × 75) | 203, 15, 5 | mm, s, s | |
| 105-109 | Tear strength after 500 | MD | ISO 4674-1 | 5 × (200 × 150) | 60 | N | 62.34 |
| 110-114 | h/70° C. | CMD | MethodA | 5 × (200 × 150) | 60 | N | 95.39 |
| 115 | Peel resistance between | MD | ISO 4578 | 1 × (360 × 150) | 40 OR CFS | N/25 mm | 43.06 |
| | surface layer & reinforcing | | | 1 × (360 × 150) | | | |
| 116 | backing after 500 h/70° C. | CMD | | 40 OR CFS | N/25 mm | 27.44 | |

TABLE 2

| | | | | Test | No. & Size of Test | | | |
|---|---|---|---|---|---|---|---|---|
| Examples | Properties | | | Methods | Specimens | Specification | Units | Result |
| | Thickness | | | ISO 2286-3 | Spaced across the | Max 3.7 | mm | 1.695 |
| | | | | | usable width | | | |
| 1-5 | Total mass per unit area | | | ISO 2286-2 | 5 × (100 × 100) | Max 2300 | g/m2 | 2185 |
| 6-8 | Static | dry | MD | ISO 8295 | 3 × (300 × 95) | 0.25 | | 0.732 |
| 9-11 | coefficient of | | CMD | | 3 × (300 × 95) | 0.25 | | 0.661 |
| 12-14 | friction | wet | MD | | 3 × (300 × 95) | 0.25 | | 0.621 |
| 15-17 | | | CMD | | 3 × (300 × 95) | 0.25 | | 0.685 |
| 18-20 | Dynamic | dry | MD | | 3 × (300 × 95) | 0.25 | | 0.416 |
| 21-23 | coefficient of | | CMD | | 3 × (300 × 95) | 0.25 | | 0.413 |
| 24-26 | fiction | wet | MD | | 3 × (300 × 95 | 0.25 | | 0.411 |
| 27-29 | | | CMD | | 3 × (300 × 95 | 0.25 | | 0.422 |

| 30-32 | Dimensional stability | | EN 434 | 3 × (240 × 240) | Plus/minus | % | 0 |
|---|---|---|---|---|---|---|---|
| | | | | | 0.2 | | |
| 33-35 | Curling | | EN 434 | 3 × (240 × 240) | Max 10 | mm | 0 |
| 36-38 | Abrasion-loss in mass | | ISO 9352 | 3 × (Φ 100) | 1000 | mg | 388 |
| 39 | 50% impact-failure energy | | ISO 6603-1 | 1 × (300 × 300) | 9 | J | 14.13 |
| | | | Method A | | | | |
| 40-44 | Tear strength | MD | ISO 4674 | 5 × (200 × 150) | 60 | N | 115.8 |
| 45-49 | | CMD | Method A | 5 × (200 × 150) | 60 | N | 106.2 |
| 50-54 | Peel resistance between | MD | ISO 4578 | 5 × (250 × 25) | 50 or CSF | N | 71.07 |
| 55-59 | surface layer & | CMD | | 5 × 250 × 25) | 50 or CSF | N | 35.59/CFS |
| | reinforcing backing | | | | | | |
| 60-64 | Peel resistance between | MD | | 5 × (250 × 25) | 20 or CSF | N | 27.15 |
| 65-69 | surface layers | CMD | | 5 × (250 × 25) | 20 or CSF | N | 27.4 |

| 80-84 | Bondability (peel resistance) | | ISO 4578 | 5 × (250 × 25) | 20 | N/25 mm | 21.8 |
|---|---|---|---|---|---|---|---|
| 85-89 | Sealability (peel resistance) | | ISO 8510-2 | 5 × (360/200 × 25) | NO AF | N/25 mm | NO AF |
| | Weldability | | EN 684 | | 250 | N/50 mm | 320 |
| 91-92 | Stain | Citric acid 10% | ISO 4586-2 | 2 × (any) | RATING 5 | | Rating 5 |
| 93-94 | resistance | Alcoholic beverages | clause 15 | 2 × (any) | RATING 5 | | Rating 5 |
| | against | red wine | procedure A | | | | |
| 95-96 | | Urea 20% solution | | 2 × (any) | RATING 5 | | Rating 5 |

| | | | | | | | |
|---|---|---|---|---|---|---|---|
| 97-99 | Flammability, vertical, | MD | AITM | 3 × (300 × 75) | 203, 15, 5 | mm, s, s | 28, 0, 0 |
| 100-102 | 12 s | CMD | 2.0002B | 3 × (300 × 75) | 203, 15, 5 | mm, s, s | 29, 0, 0 |
| 116-119 | Tear strength after 500 | MD | ISO 4674-1 | 5 × (200 × 150) | 60 | N | 95 |
| 120-124 | h/70° C. | CMD | Method A | 5 × (200 × 150) | 60 | N | 93.5 |
| 125 | Peel resistance between | MD | ISO 4578 | 1 × (360 × 150) | 40 OR CFS | N/25 mm | 28.16/CFS |
| 126 | surface layer & | CMD | | 1 × (360 × 150) | 40 OR CFS | N/25 mm | 30.36/CFS |
| | reinforcing backing after | | | | | | |
| | 500 h/70° C. | | | | | | |

The present invention is intended to include such modifications and alterations in so far as they fall within the scope of the appended claims or the equivalents thereof.

We claim:

1. A dimensionally stable continuous laminate structure comprising:
a reinforcement layer comprising, by weight, from about 20% to about 80% fiber reinforcement and from about 80% to about 20% thermoset polymer selected from polyester, phenolic, epoxy and mixtures thereof;
a surface layer comprising a substrate layer and a decorative layer, the substrate layer comprising, by weight, from about 20% to 80% by weight fiber reinforcement and from about 80% to about 20% polymer selected from polyvinyl chloride, polyester, phenolic, epoxy and mixtures thereof, and the decorative layer comprising at least one of polyvinyl chloride, acrylic, and polyurethane;
an adhesive layer disposed between the reinforcement layer and the substrate layer of the surface layer;
an adhesive primer layer disposed between the reinforcement layer and the adhesive layer, wherein the adhesive primer is of a material composition different than the adhesive layer.

2. The laminate of claim 1, wherein the reinforcement layer comprises, by weight, from about 40% to about 50% polyester.

3. The laminate of claim 2, wherein the laminate structure has an areal density of about 3000 grams per square meter or less.

4. The laminate of claim 2, wherein at least one of the reinforcement layer and the substrate layer comprises from about 100 grams per square meter to about 400 grains per square meter fiber reinforcement, and wherein the fiber reinforcement is a woven fabric.

5. The laminate of claim 2, wherein the adhesive layer comprises thermoplastic polyurethane.

6. The laminate of claim 2, wherein the adhesive primer comprises a thermoset polymer selected from the group: polyester, polyurethane, acrylic, and mixtures thereof.

7. The laminate of claim 1, wherein the adhesive layer comprises, by weight, from about 50% to about 70% polymer and from about 30% to about 50% flame retardant additive.

8. The laminate of claim 1, wherein the adhesive layer comprises no flame retardant additive.

9. The laminate of claim 1, wherein the laminate comprises from about 70 grams per square meter to about 150 grams per square meter adhesive layer disposed between the adhesive primer and the substrate layer of the surface layer.

10. The laminate of claim 1, wherein the substrate layer of the surface layer comprises, by weight, from about 60% to about 80% fiber reinforcement wherein the fiber reinforcement is a woven fabric, 20% to about 30% polyvinyl chloride and from about 5% to about 20% plasticizer.

11. The laminate of claim 9, wherein the at least one of the reinforcement layer and the substrate layer comprises from about 100 grams per square meter to about 400 grams per square meter fiber reinforcement, and wherein the fiber reinforcement is a woven fabric.

12. The laminate structure of claim 1, wherein the laminate has a peel strength between the surface layer and the reinforcement layer which is at least about 25 Newtons per 25 millimeters, according to ISO 4578 test method.

13. The laminate structure of claim 1, wherein the laminate has an impact resistance greater than about 5 Joules according to a modified ISO 6603-1 method A.

14. The laminate structure of claim 1, wherein the decorative layer has a pattern deviation from linear, in both machine in cross machine directions, of less than about 1.5 millimeters over a length of about 4 meters.

15. The laminate of claim 14, wherein the laminate has a peel strength between the surface layer and the reinforcement layer which is at least about 50 Newtons per 25 millimeters, according to ISO 4578 test method.

16. The laminate of claim 15 wherein the reinforcement layer comprises substrate layer comprises from about 100 grams per square meter to about 400 grams per square meter fiber reinforcement.

17. The laminate of claim 1, wherein the laminate is a roll-formed laminate product.

18. The laminate of claim 17, wherein the laminate is produced by a roll-forming process and has an areal density of about 3000 grams per square meter or less.

19. The laminate of claim 18, wherein the laminate has an impact resistance greater than about 5 Joules according to a modified ISO 6603-1 method A.

20. The laminate of claim 1, wherein the laminate further comprises a protective layer disposed on the decorative layer, the protective layer comprising at least one of polyvinyl chloride and polyurethane.

21. The laminate of claim 1, wherein the laminate further comprises a second decorative layer disposed on the decorative layer.

22. The laminate of claim 21, wherein the laminate further comprises a protective layer comprising at least one of polyvinyl chloride (PVC) and acrylic disposed on the second decorative layer.

23. A dimensionally stable laminate structure comprising:
a reinforcement layer comprising, by weight, from about 40% to about 50% polyester, and from about 50% to about 60% by weight fiber reinforcement;
a surface layer comprising a substrate layer and a decorative layer, the substrate layer comprising, by weight, from about 20% to about 80% PVC and from about 20% to about 80% woven fiber, and the decorative layer comprising PVC and plasticizer;
an adhesive layer disposed between the reinforcement layer and the substrate layer, the adhesive layer comprising a thermoplastic polyurethane;
an adhesive primer layer disposed between reinforcement layer and the adhesive layer, wherein the adhesive primer comprises a thermoset polymer selected from the group: polyester, polyurethane, acrylic, and mixtures thereof; and
wherein the laminate has an areal density of about 3000 gains per square meter or less.

24. The laminate of claim 23, wherein the laminate further comprises at least one of a second decorative layer disposed on the decorative layer and a protective layer disposed on the second decorative layer, the protective layer comprising polyvinyl chloride.

25. The laminate of claim 23, wherein the laminate has a peel strength between the surface layer and the reinforcement layer which ranges from about 40 Newtons per 25 millimeters to about 60 Newtons per 25 millimeters, according to ISO 4578 test method.

26. The laminate structure of claim 23, wherein the decorative layer has a pattern deviation from linear, in both machine in cross machine directions, of less than about 1.5 millimeters over a length of about 4 meters.

27. The laminate structure of claim 26, wherein at least one of the reinforcement layer and the substrate layer comprises from about 200 grams per square meter to about 400 grams per square meter glass reinforcement.

28. The laminate structure of claim 27, wherein the laminate structure has an areal density of about 2300 grams per square meter or less and the laminate has an impact resistance greater than about 5 Joules according to a modified ISO 6603-I method A.

29. The laminate structure of claim 23, wherein the laminate is a roll-formed laminate product.

30. The laminate of claim 23, wherein the laminate is produced by a roll-forming process and has an areal density of about 3000 grams per square meter or less.

31. The laminate of claim 30, wherein the laminate has an impact resistance greater than about 5 Joules according to a modified ISO 6603-I method A.

32. A method of making a laminate structure, comprising:
applying an adhesive to a first surface of an adhesive primer layer which is adhered to a reinforcement layer along a second surface of the adhesive primer opposite the first surface, the reinforcement layer comprising a woven fabric and a thermoset polymer selected from the group: polyester, phenolic, epoxy, and mixtures thereof;
applying the adhesive to a substrate layer comprising a woven fabric and a polymer selected from the group: polyvinyl chloride, polyester, phenolic, epoxy and mixtures thereof;
laminating in a continuous roll process at a temperature ranging from about 170° F. to about 300° F. the reinforcement layer and the substrate layer such that the adhesive applied to the adhesive primer layer contacts the adhesive applied to the substrate layer;
wherein the composition of the adhesive is different than the composition of the adhesive primer.

33. The method of claim 32. wherein:
the reinforcement layer comprises a glass fabric and thermoset polyester; the substrate layer comprises a glass fabric and polyvinyl chloride; and
the adhesive primer layer comprises a thermoset polymer selected from the group: polyester, polyurethane, acrylic and mixtures thereof; and
the adhesive comprises a thermoplastic polyester-based polyurethane.

34. The method of claim 32, wherein the amount of adhesive applied to both the adhesive primer layer and the substrate layer ranges from about 25 grams per square meter to about 150 grams per square meter.

35. The method of claim 32, wherein the ratio of the amount of adhesive applied to the adhesive primer layer to the amount of adhesive applied to substrate layer, ranges from about 1:1 to about 1:2.

36. The method of claim 32, wherein the peel resistance between the reinforcement layer and the decorative layer ranges from about 40 Newtons per 25 millimeters to about 60 Newtons per 25 millimeters, after aging for 500 hours at 70° C., according to ISO 4578 test method.
